(19) United States
(12) Patent Application Publication
(10) Pub. No.: US 2012/0262043 A1
(43) Pub. Date: Oct. 18, 2012

(54) READY-TO-ASSEMBLE SPACE ORGANIZER KIT AND METHODS FOR USING AND MANUFACTURING THE SAME

(76) Inventor: Stephen J. Lechert, JR., Heathsville, VA (US)

(21) Appl. No.: 13/086,729

(22) Filed: Apr. 14, 2011

(51) Int. Cl. A47B 88/20; G09F 3/00; B23P 11/00; A47B 95/00

(52) U.S. Cl. 312/348.3; 211/10; 40/299.01; 29/428

(57) ABSTRACT

A ready-to-assemble space organizer kit is provided, the kit comprising a plurality of slats including at least a primary slat and at least a secondary slat adapted to intersect with the primary slat within a space defined at least by side walls and a bottom surface. Each slat includes opposite ends and one or more intermediate channels located between the opposite ends. The one or more intermediate channels are adapted to interlock with one another within the space, and at least one of the ends engages with one of the side walls.

### TECHNICAL FIELD

The present disclosure relates to ready-to-assemble space organizer kits and methods for using and producing the kits. The present disclosure is particularly applicable for organizing spaces, as in a drawer or a basket.

### BACKGROUND

Almost every home and office contains cabinets, dressers, desks, or other similar type of fixtures with enclosed spaces (e.g., a drawer) that are used to hold various items. Such items may include cooking utensils and cutlery, articles of clothing, office supplies, tools, etc. Generally, such items can be arranged in the enclosed space (e.g., a drawer) by a user with or without any organizer. Conventional pre-fabricated organizers usually do not completely fit within the space leaving wasted space and, therefore, fall short of utilizing the entire space.

A need therefore exists for a space organizer that maximizes the accommodating capacity of entire spaces.

### SUMMARY

An aspect of the present disclosure is a ready-to-assemble space organizer kit.

Another aspect of the present disclosure is an article of furniture having a space, and a space organizer kit assembled in the space to provide one or more sections.

Another aspect of the present disclosure is a method of using a ready-to-assemble space organizer kit.

Another aspect of the present disclosure is a method of providing a ready-to-assemble space organizer kit.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

An aspect of the present disclosure is a ready-to-assemble space organizer kit comprising: a plurality of slats including at least a primary slat, and at least a secondary slat adapted to intersect with the primary slat within a space defined by at least side walls and a bottom surface, each slat having opposite ends and one or more intermediate channels located between the opposite ends, wherein the one or more intermediate channels are adapted to interlock with one another within the space, and at least one of the ends engages with one of the side walls.

Aspects include kits comprising wall elements adapted to be set against the side walls of the space, each wall element having opposite ends and one or more intermediate channels located between the opposite ends which are adapted to engage with at least one of the opposite ends of at least one slat. Further aspects include kits comprising a base adapted to be set against the bottom surface of the space, wherein each slat has upper and lower surfaces and the lower surface of each slat engages with the base of the kit. Other aspects include kits comprising at least one of: an instruction sheet having indicia for interlocking and engaging the slats, a package having indicia for interlocking and engaging the slats, and indicia on the slats at interlocking and engaging positions. The indicia may be selected from the group consisting of letters, numbers, characters, colors, symbols, and a combination thereof.

Another aspect of the present disclosure is an article of furniture having a space, and the space organizer kit assembled in the space to provide one or more sections.

According to the present disclosure, some effects may be achieved in part by a method including: providing a ready-to-assemble space organizer kit, the kit comprising a plurality of slats that include at least a primary slat, and at least a secondary slat adapted to intersect with the primary slat within a space defined by at least side walls and a bottom surface, each slat having opposite ends and one or more intermediate channels located between the opposite ends; interlocking the one or more intermediate channels with one another within the space; and engaging at least one of the ends with one of the side walls to provide one or more sections for accommodating articles.

Aspects of the present disclosure include wall, elements, each wall element having opposite ends and one or more intermediate channels located between the opposite ends. Further aspects include engaging the wall elements with at least one of the opposite ends of the each slat; and setting the wall elements against the side walls of the space. Aspects of the present disclosure include a base, and each slat and each wall element has upper and lower surfaces. Further aspects include engaging the lower surface of each slat and the lower surface of each wall element with the base; and setting the base against the bottom surface of the space. Another aspect includes providing at least one of: an instruction sheet having indicia for interlocking and engaging the slats, a package having indicia for interlocking and engaging the slats, and/or indicia on the slats at interlocking and engaging positions; and interlocking the slats and engaging the wall elements with the slats based upon the indicia. Further aspects include removing the slats from the space by releasing the one or more intermediate channels of the slats from interlocking with one another, and disengaging at least one of the ends of the each slat from one of the kit walls.

Another aspect of the present disclosure is a method including retrieving information about a space size, the space being defined at least by side walls and a bottom surface; forming a plurality of slats including at least a primary slat, and at least a secondary slat adapted to intersect with the primary slat within a space defined by at least side walls and a bottom surface, each slat having opposite ends and one or more intermediate channels located between the opposite ends; and placing the plurality of slats into a package as a ready-to-assemble space organizer kit.

Aspects of the present disclosure include providing wall elements adapted to be set against the side walls of the space, each wall element having opposite ends and one or more intermediate channels located between the opposite ends which are adapted to engage with at least one of the opposite ends of the each slat; and placing the wall elements into the package. Further aspects include providing a base adapted to be set against the bottom surface of the space, wherein each slat has upper and lower surfaces and the lower surface of each slat engages with the base of the kit; and placing the base into the package. Other aspects include at least one of: providing on the package indicia for interlocking the slats and engaging the slats with the wall elements, putting into the package an instruction sheet describing the indicia, and/or marking on the slats with matching indicia at interlocking and engaging positions.

Additional aspects and technical effects of the present disclosure will become readily apparent to those having ordinary skill in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIGS. 1A through 1D are perspective views of a space organizer kit assembled and ready to be placed within an enclosed space (e.g., a drawer), according to various embodiments;

FIG. 2 is a perspective view of components of a ready-to-assemble space organizer kit, according to embodiment of the present disclosure;

FIG. 3 includes perspective views of two slats of a ready-to-assemble space organizer kit before and after engagement, according to an embodiment;

FIGS. 4A and 4B are perspective views of one kit wall and one slat ready-to-assemble space organizer kit before and after engagement, according to various embodiments;

FIG. 5 is a flowchart of a process for using ready-to-assemble space organizer kit, according to an embodiment; and

FIG. 6 is a flowchart of a process for producing a ready-to-assemble space organizer kit, according to another embodiment.

### DETAILED DESCRIPTION

In the following description, for the purposes of explanation, numerous specific details are set forth in order to provide a thorough understanding of exemplary embodiments. It should be apparent to those having ordinary skill in the art, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves the problem of conventional pre-fabricated organizers in failing to fully utilize a space, as within a drawer.

Embodiments of the present disclosure includes a ready-to-assemble space organizer kit comprising: a plurality of slats including at least a primary slat, and at least a secondary slat adapted to intersect with the primary slat within a space defined by at least side walls and a bottom surface, each slat having opposite ends and one or more intermediate channels located between the opposite ends, wherein the one or more intermediate channels are adapted to interlock with one another within the space, and at least one of the ends engages with one of the side walls.

Still other aspects, features, and technical effects of fully utilizing a space and easily moving an organizer from one space to another space, e.g., from one drawer to another drawer, will be readily apparent to those having ordinary skill in the art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

As used herein, the term “enclosed space” refers to a space within fixtures, such as cabinets, dressers, desks, etc. that are used to hold and/or accommodate various items, and does not exclude a space that is not completely enclosed or a space normally open to view. Although various embodiments are described with respect to a drawer, it should be understood that various embodiments of the present disclosure may be used with baskets, open shelves, enclosed shelves, storage boxes, storage cabinets, wall units, etageres, or any area capable of being divided into smaller spaces or sections.

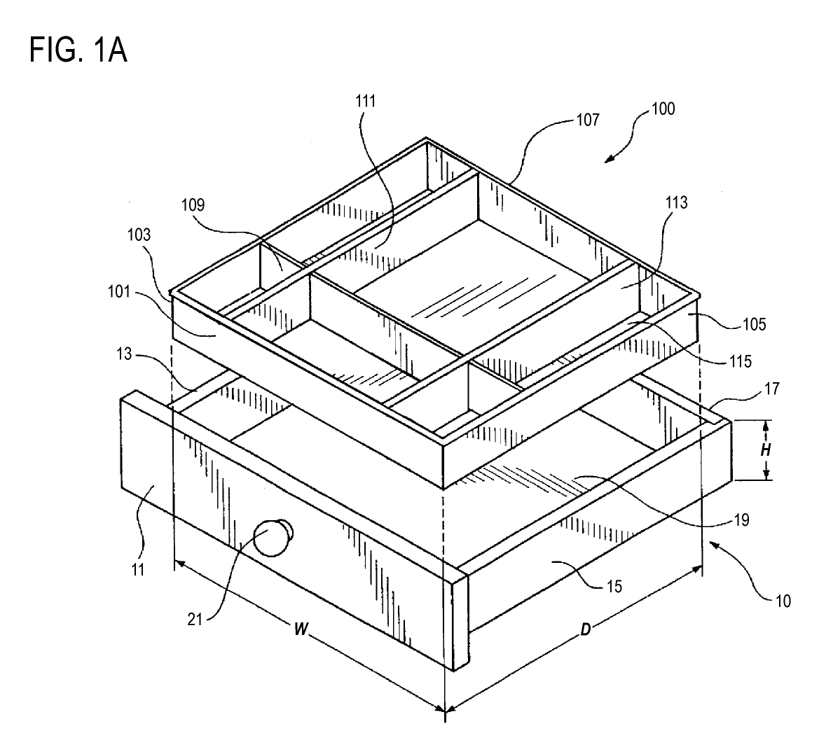

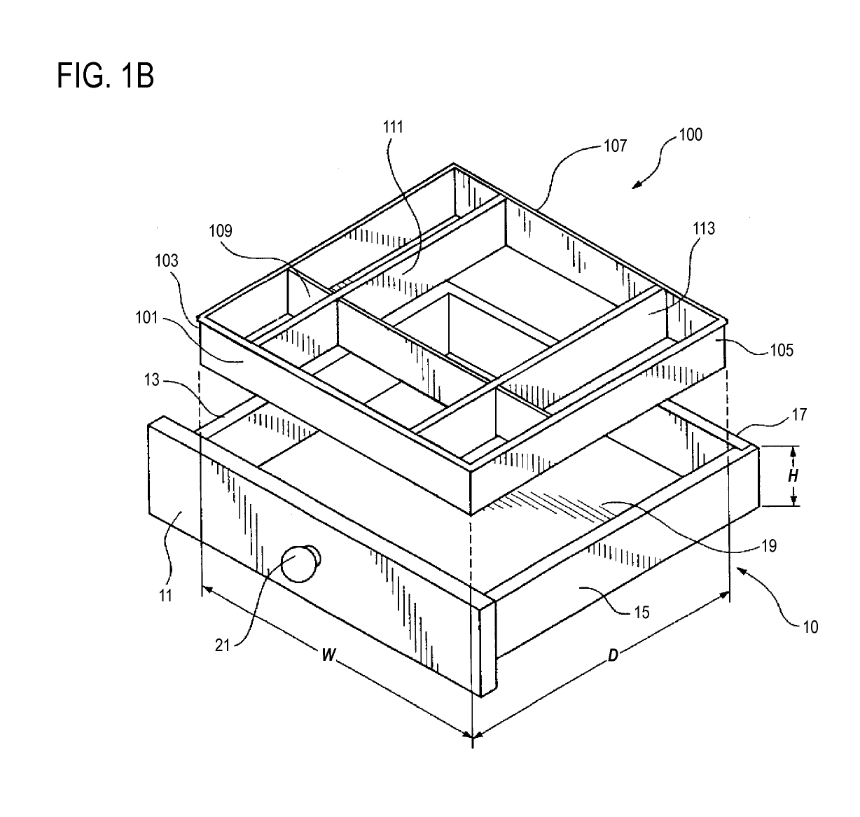

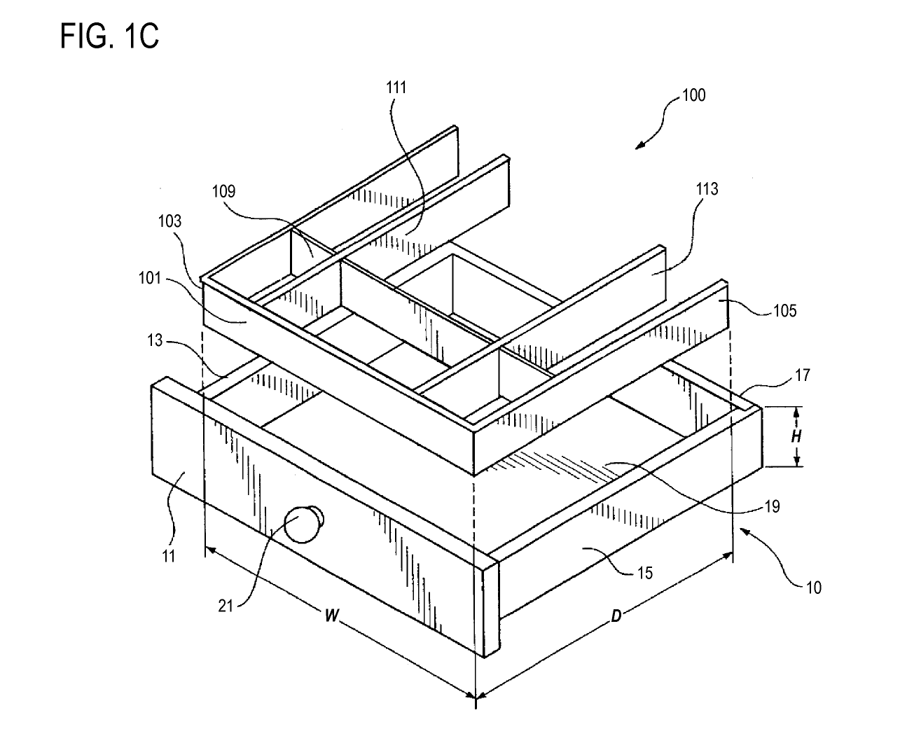

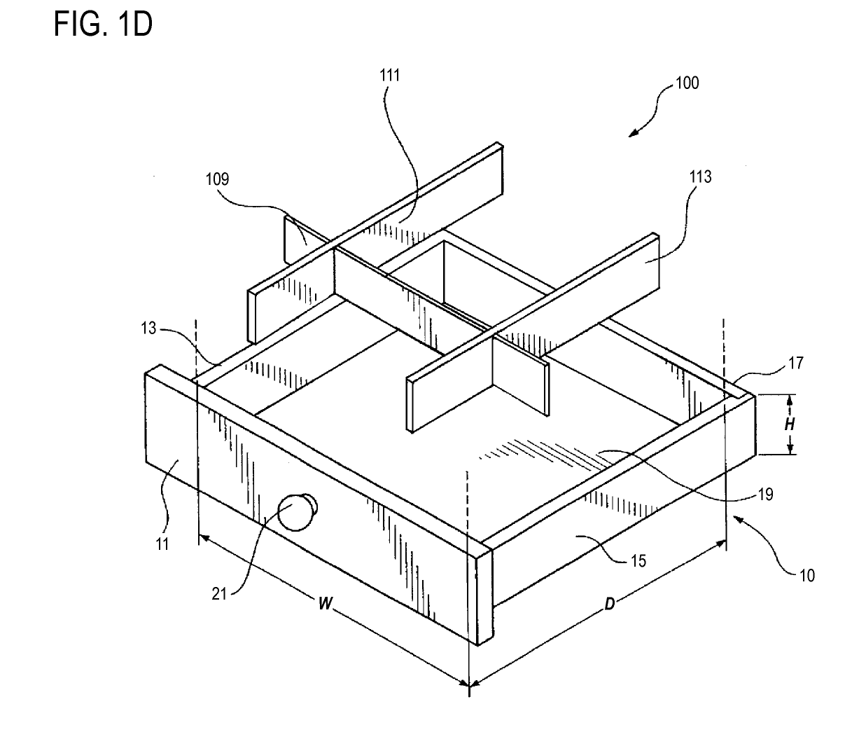

FIGS. 1A through 1D are perspective views of a space organizer kit assembled and ready to be placed within an enclosed space (e.g., a drawer), according to various embodiments. As noted previously, there exists a need for a space organizer capable of maximizing the utility of an entire space. The present disclosure addresses and solves this problem by providing a ready-to-assemble space organizer kit 100 of FIG. 1, tailored or capable of being tailored to subdivide various spaces.

In FIG. 1A, a space organizer kit 100 is designed to be arranged in a space defined by a drawer 10. In an embodiment, the space organizer kit 100 is readily installed without requiring any of the kit components to be cut or otherwise sized or permanently or temporarily altered. The size dimensions of popular drawers can easily be obtained via field surveys or queries to drawer manufacturers. By way of example, popular drawer dimensions of width by depth include 29⅛″×11⅛″, 14⅛″×26⅛″, 17⅛″×23⅛″, 16¼″×16½″ and 16⅝″×16½″. The most popular heights include 3⅛″ and 3⅝″. An assembled space organizer kit 100 fits smugglingly or precisely within the drawer 10 to fully utilized the space inside the drawer 10. The space organizer kit 100 is well suited for use in drawers often found in residences, office, factories, etc. It will be appreciated that embodiments of the present disclosure can be utilized with drawers and other enclosed spaced which are larger or smaller than the specified range of dimensions.

In other embodiments, when the drawers are custom-made or of made of other sizes, such as 19″×18″, 11″×18″, 13″×12½″, etc., the components of the space organizer kit 100 can be cut then fitted into the drawers.

As shown in FIG. 1A, the drawer 10 has an inside width W, an inside depth D, and an inside height H. The drawer 10 comprises a front side wall 11 with a knob 21, a left side wall 13, a right side wall 15, a back side wall 17, and a bottom surface 19. The drawer 10 is merely exemplary of the various spaces into which embodiments of the present disclosure can be installed. The drawer 10 can be a kitchen drawer, a desk drawer, a dresser drawer, a file cabinet drawer, etc. The read-to-assemble space organizer kit 100 can fit into other types of spaces, such as open shelves, enclosed shelves, storage boxes, storage cabinets, etc.

In FIG. 1A, the space organizer kit 100 includes a front wall element 101, a left side wall element 103, a right side wall element 105, a back wall element 107, a primary slat 109, a secondary slat 111, a tertiary slat 113, and a base 115. Additional slats can be added as desired to divide the space depending on the user's preferences.

FIG. 1B is a perspective view of the space organizer kit assembled and ready to be placed within a drawer without the base 115, according to another embodiment. The base 115 is optionally provided for protecting the surface of the drawer bottom surface 19 from scratches. The base 115 need not be large enough to cover the entire bottom surface of the drawer. In other embodiments, the base size is determined by the user's preferences. The user may prefer to cover only one or more compartments of the space. When applying the kit in a pullout basket/shelf, e.g., for storing vegetables, spices, linens, toys, etc., the base 115 can be provided to prevent objects from falling via the basket/shelf.

The user may install the kit 100 without installing the base 115. Alternatively, the user can obtain a kit that does not contain the base 115, thereby reducing the cost of the kit. The kit without the base 115 may contain walls and slats having the same height as the walls and slats of the kit 100. In another embodiment, the kit without the base 115 contains walls and slats slightly higher than the walls and slats of the kit 100 to compensate for the lost height caused by removing the base 115.

FIG. 1C is a perspective view of another embodiment of a space organizer kit assembled and ready to be placed within a drawer. In this embodiment, the optional back wall 107 for protecting the back side wall 17 of the drawer from any marks and the optional base 115, are not included. The marks may be caused by light exposure such that the exposed portions of the drawer back side wall 17 have a lighter color than those portions covered by the right and left side walls 103, 105 and the slats 103, 105. The user may install the kit 100 without installing the back wall 107 and the base 115. Alternatively, the user can obtain a kit that comes without the back wall 107 and the base 115 at a reduced cost. The kit without the back wall 107 may include right and left side walls and its primary and tertiary slats having the same length as the side walls 103, 105 and the slats 111, 113 of the kit 100. In another embodiment, the kit without the back wall 107 may include walls and slats slightly longer than the side walls and primary and tertiary slats of the kit 100 to compensate for the lost length caused by removing the back wall 107. In yet another embodiment, the kit without the base 115 may include walls and slats slightly higher than the walls and slats of the kit 100 to compensate for the lost height caused by removing the base 115.

FIG. 1D is a perspective view of the space organizer kit assembled and ready to be placed within a drawer without the walls 101, 103, 105, 107 and the base 115, according to another embodiment. Like the back wall 107, the walls 101, 103, 105 are optionally provided for protecting walls of the drawer from any marks. The user may install the kit 100 without installing the four walls 101, 103, 105, 107 and the base 115. Alternatively, the user can obtain a kit that does not include walls 101, 103, 105, 107, and the base 115 to save cost.

A kit without the left and right side walls may include a secondary slat having the same length as the slat 109 of the kit 100. In another embodiment, the kit without the left and right side walls may include a secondary slat longer than the secondary slats 109 of the kit 100 to compensate for the lost length caused by removing the left and right side walls 103, 105. In yet another embodiment, the kit without the front and back walls may include right and left side walls and its primary and tertiary slats having the same length as the side walls 103, 105 and the slats 111, 113 of the kit 100. In another embodiment, the kit without the front and back walls may include walls and slats slightly longer than the side walls and primary and tertiary slats of the kit 100 to compensate for the lost length caused by removing the front and back walls 101, 107. In yet another embodiment, the kit without the base 115 may include walls and slats slightly higher than the walls and slats of the kit 100 to compensate for the lost height caused by removing the base 115.

The above-discussed embodiments may be fabricated from different materials using different techniques, depending on the material of the components. The space organizer kit 100 can be fabricated from any known elastomeric materials or stiff, rigid, non-bendable materials. Elastomeric materials can be shaped by injection molding techniques, etc. Examples of stiff, rigid, non-bendable materials include wood, bamboo, plastics, metals, such as brass and other alloys, fiber glass, composites, etc.

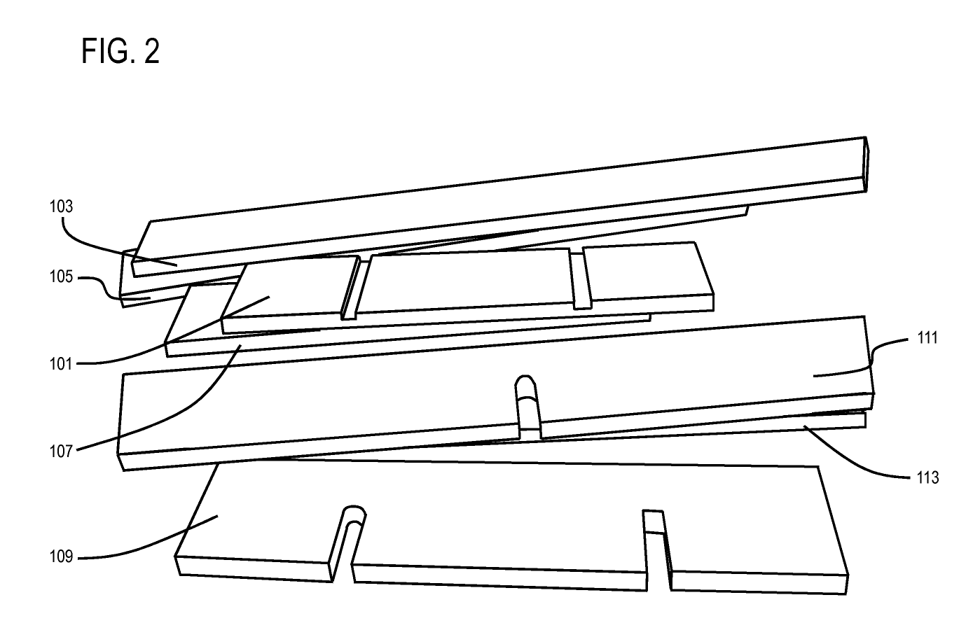

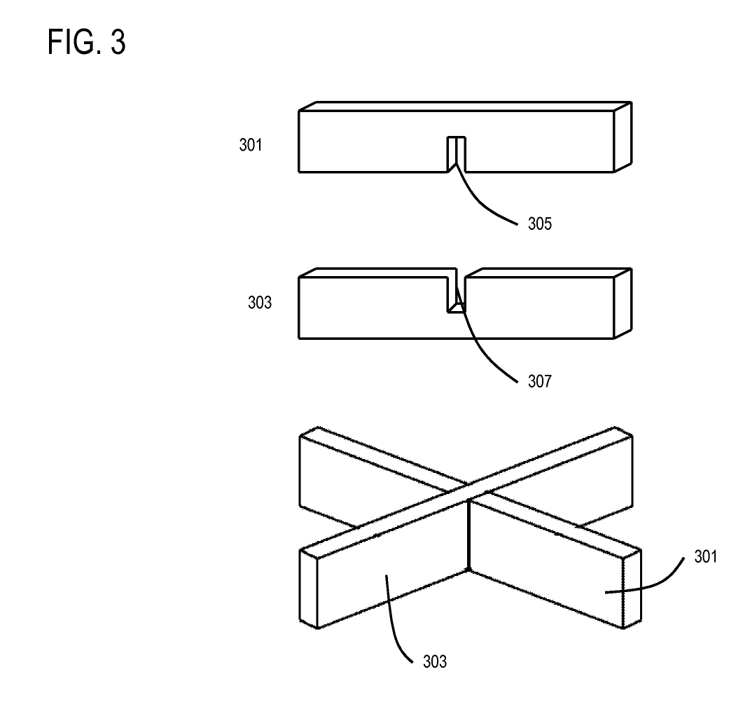

FIG. 2 is a perspective view of components of a ready-to-assemble space organizer kit according to the embodiment of FIG. 1. As can be seen in FIG. 2, the walls and the slats of the kit 100 have engaging or interlocking means such as grooves 305, 307 shown in FIG. 3, to hold the slats 109, 111, 113 to each other or to hold the slats towards the walls 101, 103, 105, 107.

FIG. 3 illustrates perspective views of two slats of a ready-to-assemble space organizer kit before and after engagement. In this embodiment, a slat 301 has a groove 305 and a slat 303 has a groove 307. The two grooves 305 and 307 may be engaged by a user to hold the two slats in a desired interlocking manner. The shapes and dimensions of the grooves can vary based upon user preferences and manufacturing considerations. The two grooves can be or equal or different in length. It will be appreciated that many different equivalent structures can perform the function of the means for interlocking.

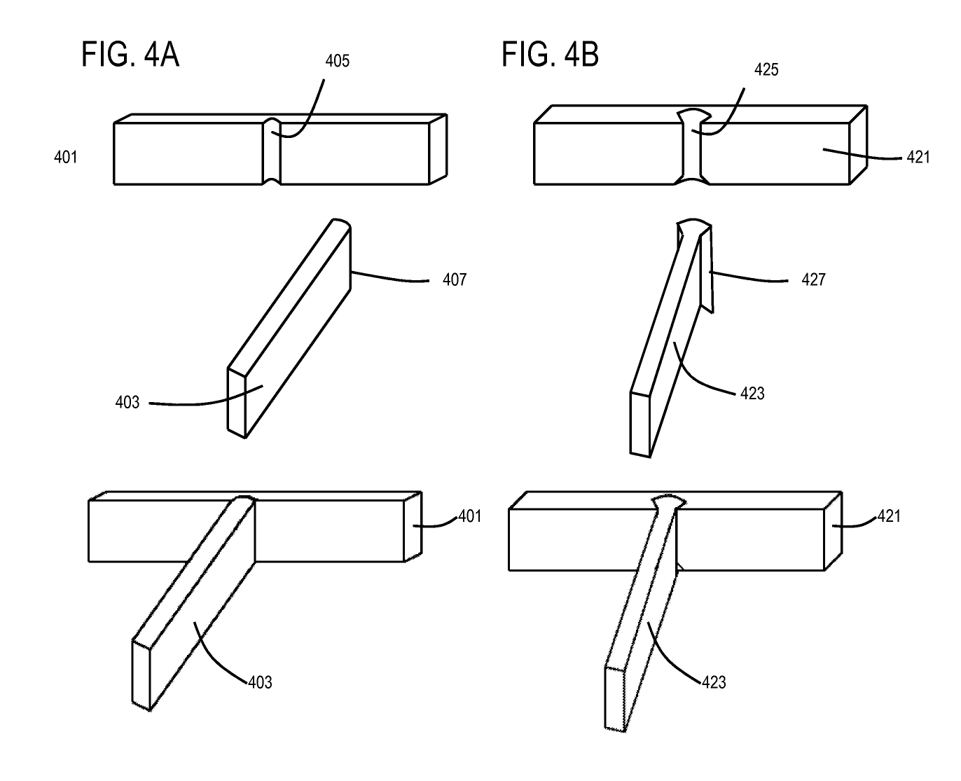

FIGS. 4A and 4B are perspective views of a wall element and slat of the ready-to-assemble space organizer kit before and after engagement, for use in various embodiments. A wall 401 has a channel 405 and a slat 403 has a convex end 407. The channel 405 and the convex end 407 may be engaged by a user to hold the wall and the slat in a desired interlocking manner. The shapes and dimensions of the channel and the convex end can vary based upon user preferences and manufacturing considerations. The channel and the convex end can be of the full height or shorter. In FIG. 4A, the channel 405 is formed in the shape of a female half circle, and the convex end 407 has a matching male shape to fill the channel. In FIG. 4B, the channel 425 is formed with a female triangular-style shape, and the convex end 427 has a matching male shape to fill the channel. To save manufacturing cost, the wall 401 and the slat 403 may be made with flat surfaces and flat ends, such that they are merely pressed against each other without any special engaging means. It will be appreciated that many different equivalent structures can perform the function of the means for engaging.

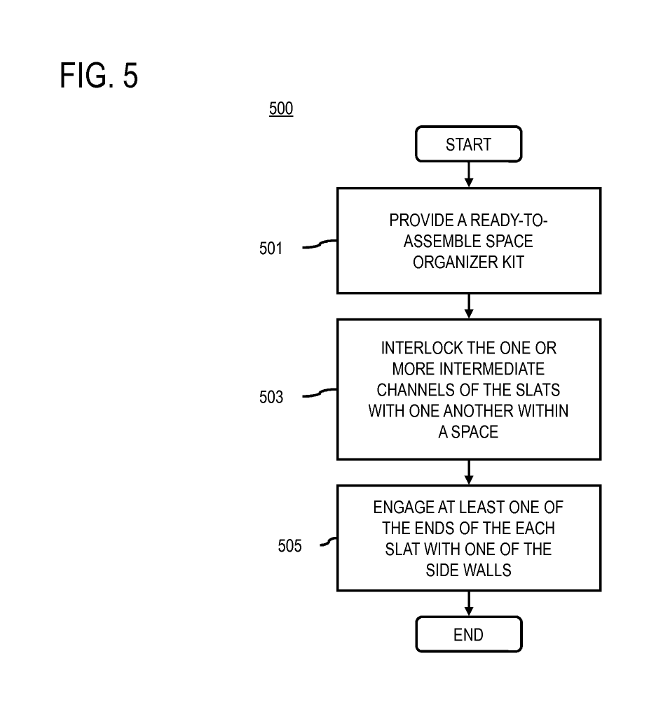

FIG. 5 is a flowchart of a process for using ready-to-assemble space organizer kit, according to several embodiments of the present disclosure. In such embodiments, a user performs the process 500. In step 501, the user obtains or provides a ready-to-assemble space organizer kit. The kit comprises a plurality of slats that include at least a primary slat, and at least a secondary slat adapted to intersect with the primary slat within a space defined by at least side walls and a bottom surface. Each slat has opposite ends and one or more intermediate channels located between the opposite ends. The user interlocks the one or more intermediate channels of the slats with one another within the space (Step 503). The user then engages at least one of the ends of the each slat with one of the side wall to provide one or more sections for accommodating articles (Step 505). If the user decides to install the wall elements of the kit, the user engages the wall elements with at least one of the opposite ends of the each slat, and sets the wall elements against the side walls of the space. The kit may further comprise a base. If the user decides to install the base of the kit, the user engages the lower surface of each slat and the lower surface of each wall element with the base, and sets the base against the bottom surface of the space.

For the user's convenience, indicia may be provided for interlocking the slats and for engaging the walls with the slats. The indicia may be provided on the components of the kit, on an instruction sheet, and/or on the package of the kit. The user may interlock the slats and engage the walls with the slats based upon the indicia. The indicia may include numbers, characters, colors, symbols, or a combination thereof.

The user can easily remove the slats from the space by releasing the one or more intermediate channels of the slats from interlocking with one another within the space. The user can easily disengage at least one of the ends of the each slat with one of the walls. As such the user can easily move the kit from one space to another space.

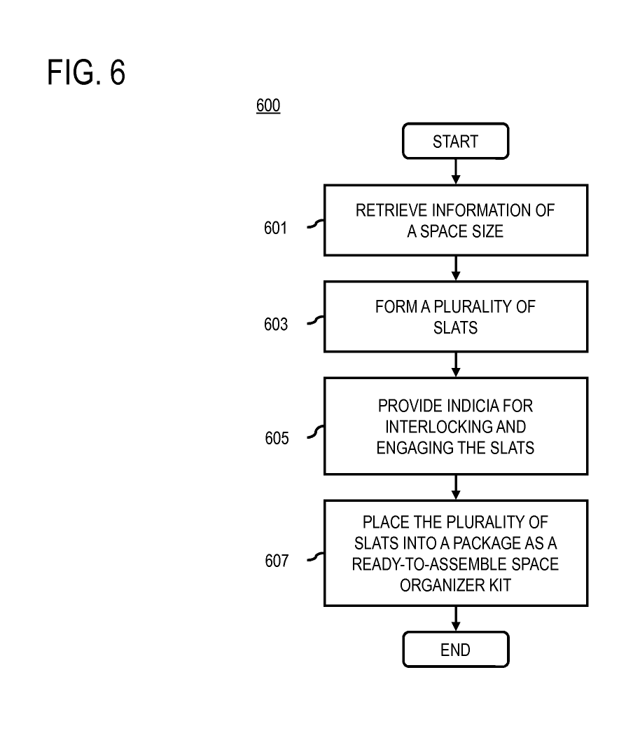

FIG. 6 is a flowchart of a process 600 for producing a ready-to-assemble space organizer kit, according to several embodiments of the present disclosure. In some embodiments, a manufacturer retrieves information of a space size (Step 601). The space is defined at least by side walls and a bottom surface. The manufacturer forms a plurality of slats including at least a primary slat, and at least a secondary slat adapted to intersect with the primary slat within a space defined by at least side walls and a bottom surface (Step 603). Each slat has opposite ends and one or more intermediate channels located between the opposite ends. In other embodiment, the manufacturer also forms four walls, and includes the four walls in the package. Each wall has one or more intermediate channels located between two ends. In yet other embodiments, the manufacturer forms a base and includes the base in the package.

The manufacturer may provide indicia for interlocking and engaging the slats (Step 605). The indicia may be provided on the components of the kit, on an instruction sheet, and/or on the package of the kit. The manufacturer may place the plurality of slats, and optional wall elements, base, and indicia sheet into the package as a ready-to-assemble space organizer kit (Step 607).

The means for interlocking the slats and/or engaging the slats with the walls, i.e., means for interlocking or holding various components or elements together need not be formed as part of the component or element. Instead, such means may include separately provided fasteners or other interlocking/holding means. The present disclosure is not limited to flat and/or straight components/elements, but may include relatively non-flat and non-straight components/elements, to form sections of various shapes, e.g., circular, semi-circular, triangular, and various polygonal shapes.

It is to be understood that the size of the walls and slats of the kit 100 in relation to the space in the drawer can vary in accordance with the anticipated and/or actual needs or preferences of the user. It is also within the scope of the present disclosure that any number of slats or kit components/elements may be included in a package, and that separate packages may be provided containing separate additional components/elements with or without indicia.

In view of the foregoing, it will be appreciated that the above-discussed embodiments of the present disclosure provide a ready-to-assemble kit for organizing an enclosed space (such as a drawer) which can be sized to closely or precisely fit within the enclosed space. Embodiments of the present disclosure avoid the need to cut or permanently alter conventional drawer organizers. Embodiments of the present disclosure enable a user to easily assemble a space organizer, and to easily disassembly the space organizer and move it to another space location. Embodiments of the present disclosure also enable a manufacturer to provide organizer kits that can be used to section a variety of different spaces,

The embodiments of the present disclosure can achieve several technical effects, including fully utilizing a variety of different enclosed spaces, thereby enabling a user to compartmentalize and maximize storage space, and to easily remove the sections and organize another space, as desired The present disclosure enjoys applicability in sectioning any of various types of space, such as spaces within fixtures, e.g., cabinets, dressers, desks, wall units, etageres, for accommodating various items.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A ready-to-assemble space organizer kit comprising:
a plurality of slats including at least a primary slat, and at least a secondary slat adapted to intersect with the primary slat within a space defined by at least side walls and a bottom surface, each slat having opposite ends and one or more intermediate channels located between the opposite ends, wherein the one or more intermediate channels are adapted to interlock with one another within the space, and at least one of the ends engages with one of the side walls.

2. The kit of claim 1, further comprising:
wall elements adapted to be set against the side walls of the space, each wall element having opposite ends and one or more intermediate channels located between the opposite ends which are adapted to engage with at least one of the opposite ends of the each slat.

3. The kit of claim 2, further comprising:
a base adapted to be set against the bottom surface of the space, wherein each slat has upper and lower surfaces and the lower surface of each slat engages with the base of the kit.

4. The kit of claim 1, wherein the slats comprise a material selected from the group consisting of elastomerics, wood, bamboo, plastics, metals, fiber glass, composites, and a combination thereof.

5. The kit of claim 1, wherein the space is defined by four walls and a bottom of a drawer or a basket.

6. The kit of claim 1, further comprising at least one of:
an instruction sheet having indicia for interlocking and engaging the slats,
a package having indicia for interlocking and engaging the slats, and/or
indicia on the slats at interlocking and engaging positions.

7. The kit of claim 1, wherein the indicia is selected from the group consisting of letters, numbers, characters, colors, symbols, and a combination thereof.

8. An article of furniture comprising:
a space; and
the kit of claim 1 assembled in the space to provide one or more sections.

9. A method comprising:
providing a ready-to-assemble space organizer kit, the kit comprising a plurality of slats that include at least a primary slat, and at least a secondary slat adapted to intersect with the primary slat within a space defined at least by side walls and a bottom surface, each slat having opposite ends and one or more intermediate channels located between the opposite ends;
interlocking the one or more intermediate channels with one another within the space; and
engaging at least one of the ends with one of the side walls to provide one or more sections for accommodating articles.

10. The method of claim 9, wherein the kit further comprises wall elements, each wall element having opposite ends and one or more intermediate channels located between the opposite ends,
the method further comprising:
engaging the wall elements with at least one of the opposite ends of the each slat; and
setting the wall elements against the side walls of the space.

11. The method of claim 10, wherein the kit further comprises a base, each slat and each wall element having upper and lower surfaces, the method further comprising:
engaging the lower surface of each slat and the lower surface of each wall element with the base; and
setting the base against the bottom surface of the space.

12. The method of claim 10, further comprising:
providing at least one of:
an instruction sheet having indicia for interlocking and engaging the slats,
a package having indicia for interlocking and engaging the slats, and/or
indicia on the slats at interlocking and engaging positions; and
interlocking the slats and engaging the kit walls with the slats based upon the indicia.

13. The method of claim 12, wherein the indicia is selected from the group consisting of letters, numbers, characters, colors, symbols, and a combination thereof.

14. The method of claim 10, further comprising:
removing the slats from the space by releasing the one or more intermediate channels of the slats from interlocking with one another, and disengaging at least one of the ends of the each slat from one of the wall elements.

15. The method of claim 9, wherein the slats are selected from the group consisting of elastomerics, wood, bamboo, plastics, metals, fiber glass, composites, and a combination thereof.

16. The method of claim 9, wherein the space is defined by four walls and a bottom of a drawer or a basket.

17. A method comprising:
retrieving information about a space size, the space being defined by at least side walls and a bottom surface;
forming a plurality of slats including at least a primary slat, and at least a secondary slat adapted to intersect with the primary slat within a space defined at least by side walls and a bottom surface, each slat having opposite ends and one or more intermediate channels located between the opposite ends; and
placing the plurality of slats into a package as a ready-to-assemble space organizer kit.

18. The method of claim 17, further comprising:
providing wall elements adapted to be set against the side walls of the space, each wall element having opposite ends and one or more intermediate channels located between the opposite ends which are adapted to engage with at least one of the opposite ends of the each slat; and
placing the wall elements into the package.

19. The method of claim 18, further comprising:
providing a base; and
placing the base into the package.

20. The method of claim 18, further comprising:
providing indicia on the package for interlocking the slats and engaging the slats with the wall elements,
placing an instruction sheet describing the indicia into the package, and/or
marking the slats with matching indicia at interlocking and engaging positions.
